(19) United States
(12) Patent Application Publication
(10) Pub. No.: US 2024/0394533 A1
(43) Pub. Date: Nov. 28, 2024

(54) METHOD AND A SYSTEM FOR TRAINING A CHATBOT SYSTEM

(71) Applicant: Direct Cursus Technology L.L.C, Dubai (AE)

(72) Inventors: Nikolay ZINOV, Krasnogorsk (RU); Artem KORENEV, Obninsk (RU)

(21) Appl. No.: 18/669,758

(22) Filed: May 21, 2024

(30) Foreign Application Priority Data
May 23, 2023 (RU) 2023113361

(51) Int. Cl. G06N 3/08; G06N 5/01

(52) U.S. Cl. CPC G06N 3/08; G06N 5/01

(57) ABSTRACT

A method and server for training a chatbot system to generate machine-generated answers to users' requests of users are provided. The method comprises: acquiring dialogue data including textual representations of dialogue pairs; acquiring fact data including textual representations of facts; identifying, from the fact data, for a given dialogue pair, a fact relevant thereto; generating a training set of data including a plurality of training digital objects, a given one of which includes the textual representations of: (i) a human request of the given dialogue pair; (ii) the fact; and (iii) a human answer of the given dialogue pair, responsive to the human request; feeding the training set of data to the chatbot system, causing the chatbot system to generate a machine-generated answer; and optimizing a difference between the machine-generated answer and the human answer, thereby training the chatbot system to generate the machine-generated answers to the users' requests.

### CROSS-REFERENCE

The present application claims priority to Russian Patent Application No. 2023113361, entitled “Method and a System for Training a Chatbot System”, filed May 23, 2023, the entirety of which is incorporated herein by reference.

### FIELD

The present technology relates generally to the field of natural language processing; and in particular, to methods and systems for training a chatbot system to generate natural language answers to users' requests.

### BACKGROUND

Chatbot systems (also known as “virtual assistant applications”), such as an Alexa™ chatbot system, an ALISA™ chatbot system, or a Siri™ chatbot system, can allow for an improved interaction between a user and certain online services (for example, online shopping platforms, online booking systems, and the like) and/or their electronic device. This is especially the case when the user is a novice or an impaired user and is thus currently unable to use machine-user interfaces of such online services and/or those of the electronic device to effectively interact therewith. For example, a user who is driving or a user who is visually impaired may not be able to use the touch screen keyboard associated with their electronic device to navigate through a doctor's web site to make an appointment therewith or that of the online shopping platform to submit an order. At the same time, a customer service personnel of these online services may not be readily available to assist such users due to, for example, an increased number of requests from other users.

For example, the given chatbot system can be executed by an online video streaming platform (such as a Netflix™ online video streaming platform or Kinpoisk™ online video streaming platform, as an example) for assisting the users in selecting a film or a show to watch. In this example, the user can submit a request in a natural language, for example: “Hey, wanna watch something funny”. In response, the given chatbot system can be configured to (i) analyze the user's request to determine the user's intent; (ii) transmit the user's intent, for example, to a recommendation engine of the online video streaming platform to generate a list of relevant comedy shows responsive to the user's intent; and (iii) provide an answer to the user's request including the list of recommended comedy shows, such as: “Here is a list of comedy shows you've been looking for: . . . ”.

In another example, the given chatbot system can be executed by an online listing platform (such as an Avito™ online listing platform or a Kijiji™ online listing platform) for assisting the users in selecting items for purchase available at the online listing platform. In this example, the user's request can read “Can you show me the best phone for less than $1000?”. Similarly, in response, the chatbot system can be configured to generate an answer including a list of phones, prices of which are under $1000, determined by the recommendation engine. By doing so, the given chatbot system can be used for navigating the user through a respective online service and answering to their requests thereat.

However, one of the drawbacks associated with such chatbot systems is that the answers provided thereby may be perceived as being unnatural and bland, not corresponding to a style of the users' requests. This may affect user experience of the users with the given chatbot system causing the users to avoid communicating their requests via the chatbot systems, which may result in overall dissatisfaction of the users with the associated online services.

Certain prior art approaches have been proposed to tackle the above identified technical problem.

An article authored by Paranjape et al., entitled “HINDSIGHT: POSTERIOR-GUIDED TRAINING OF RETRIEVERS FOR IMPROVED OPEN-ENDED GENERATION”, and published by Sandford University on Oct. 14, 2021, discloses using an additional guide retriever that is allowed to use the target output and “in hindsight” retrieve relevant passages during training. More specifically, the article is directed to a guide retriever after the posterior distribution Q of passages given the input and the target output and train it jointly with the standard retriever and the generator by maximizing the evidence lower bound (ELBo) in expectation over Q. For informative conversations from the Wizard of Wikipedia dataset, with posterior-guided training, the retriever finds passages with higher relevance in the top-10 (23% relative improvement), the generator's responses are more grounded in the retrieved passage (19% relative improvement) and the end-to-end system produces better overall output (6.4% relative improvement).

U.S. Pat. No. 11,068,660-B2 issued on Jul. 20, 2021, assigned to Koninklijke Philips NV, and entitled “SYSTEMS AND METHODS FOR NEURAL CLINICAL PARAPHRASE GENERATION” discloses to a paraphrase generation system comprising one or more hardware processors and/or other components. The system is configured to obtain a training corpus. The training corpus comprises language and known paraphrases of the language. The system is configured to generate, based on the training corpus, a word-level attention-based model and a character-level attention-based model. The system is configured to provide one or more candidate paraphrases of a natural language input based on both the word-level and character-level attention-based models. The word-level attention-based model is a word-level bidirectional long short-term memory (LSTM) network and the character-level attention-based model is a character-level bidirectional LSTM network. The word-level and character level LSTM networks are generated based on words and characters in the training corpus. In some embodiments, the LSTM networks are stacked residual LSTM networks comprising residual connections between stacked layers of a given LSTM network.

### SUMMARY

It is an object of the present technology to ameliorate at least some of the inconveniences present in the prior art.

The developers of the present technology have appreciated that the given chatbot system can be configured to provide more natural answers to the users' requests if along with a given user's request, the chatbot system can be configured to consider a fact, determined to be relevant to the given user's request.

More specifically, according to certain non-limiting embodiments of the present technology, the chatbot system can comprise: (i) a semantic similarity machine-learning model that is configured to generate vector embeddings of text input thereto, such as textual representations of the users' requests; and (ii) a generative model configured to generate respective answers to the users' requests based on the vector embeddings from the semantic similarity model.

Further, in at least some non-limiting embodiments of the present technology, the present methods and systems are directed to training the chatbot system to generate more natural answers to the users' requests by feeding to the generative model, along with the vector embedding of a given training user request, the vector embedding of a respective fact determined to be relevant to the given training user request. By doing so, the chatbot system can be trained to provide the answers to the users' request in the context of the respective facts relevant to the users' requests, which may thus enable improvement of the style of the answers generated by the chatbot system. In other words, the so generated answers of the chatbot system can be perceived by the users as comprising part of natural speech, similar to that produced by human beings. This may increase satisfaction of the users with the chatbot system and with the online service associated therewith, in general.

More specifically, in accordance with a first broad aspect of the present technology, there is provided a computer-implemented method of training a chatbot system to generate machine-generated answers to users' requests of users of the chatbot system. The chatbot system includes: (i) a semantic similarity machine-learning (ML) model configured to identify respective facts relevant to the users' requests; and (ii) a generative ML model to be trained to generate textual representations of the machine-generated answers to the users' requests based on the users' request and the respective facts. The method is executable by a server including a processor. The method comprises: acquiring, by the processor, dialogue data including (i) textual representations of human requests of dialogues of the users in a natural language; and (ii) textual representations of respective human answers of the dialogues, responsive to the human requests; acquiring, by the processor, fact data including textual representations of facts; identifying, by the processor, using the semantic similarity ML model, from the fact data, for a given dialogue pair including textual representations of a given human request and a respective human answer responsive thereto from the dialogue data, the textual representation of a respective fact, which is relevant to at least one of the given human request and the respective human answer; generating, by the processor, a training set of data including a plurality of training digital objects, a given one of which includes: (i) the textual representation of the given human request; (ii) the textual representation of the respective fact; and (iii) a respective label being the textual representation of the respective human answer responsive to the given human request; feeding, by the processor, the training set of data to the chatbot system, the feeding including: for the given training digital object of the plurality of training digital objects, feeding, by the processor, a concatenation of the textual representation of the given human request and the textual representation of the respective fact to the generative ML model to generate the textual representation of a respective machine-generated answer to the given human request given a context of the respective fact; and optimizing, by the processor, a difference between the respective machine-generated answer and the respective human answer to the given human request, thereby training the chatbot system to generate the machine-generated answers to the users' requests.

In some implementations of the method, the identifying, using the semantic similarity ML model, the respective fact for the given dialogue pair of textual representations comprises: feeding, by the processor, each one of: (i) the textual representations of the human requests; (ii) the textual representations of the human answers; and (iii) the textual representations of the facts, to the semantic similarity ML model, to generate respective vector embeddings of each one of (i) the textual representations of the human requests; (ii) the textual representations of the human answers; and (iii) the textual representations of the facts; mapping, by the processor, the respective vector embeddings to a vector space; and identifying, by the processor, the respective fact relevant to the at least one of the given human request and the respective human answer as being a fact associated with the respective vector embedding that is closest to the respective vector embedding of the at least one of the given human request and the respective human answer in the vector space.

In some implementations of the method, the identifying further comprises applying, by the processor, a k-nearest neighbors algorithm.

In some implementations of the method, the identifying further comprises applying, by the processor, a heuristic algorithm.

In some implementations of the method, the heuristic algorithm comprises a ranking function.

In some implementations of the method, the ranking function is a BM25 ranking function.

In some implementations of the method, the respective fact is for providing a context to the given dialogue pair.

In some implementations of the method, the concatenation of the textual representation of the given human request and the textual representation of the respective fact comprises a concatenation of respective vector embeddings of the given human request and of the respective fact in a given vector space.

In some implementations of the method, the optimizing the difference comprises optimizing a loss function representative of the difference between the respective machine-generated answer and the respective human answer.

In some implementations of the method, the method further comprises using the chatbot system for generating the machine-generated answers to the users' requests, the using comprising: receiving, by the processor, the textual representation of an in-use human request of a given user; identifying, by the processor, using the semantic similarity ML model, from the fact data, the respective fact relevant to the in-use human request; feeding, by the processor, a concatenation of the textual representations of the in-use human request and the respective fact to the generative ML model, thereby causing the generative ML model to generate the textual representation of a respective in-use machine-generated answer responsive to the in-use human request given the context of the respective fact.

In some implementations of the method, each one of the semantic similarity ML model and the generative ML model is a Transformer-based ML model.

In some implementations of the method, the generative ML model is devoid of an encoder portion of the Transformer-based ML model.

In some implementations of the method, the chatbot system is one of (i) a text-to-text chatbot system; (ii) text-to-speech chatbot system; (iii) a speech-to-text chatbot system; and (iv) a speech-to-speech chatbot system.

In accordance with a second broad aspect of the present technology, there is provided a server for training a chatbot system to generate machine-generated answers to users' requests of users of the chatbot system. The chatbot system includes: (i) a semantic similarity machine-learning (ML) model configured to identify respective facts relevant to the users' requests; and (ii) a generative ML model to be trained to generate textual representations of the machine-generated answers to the users' requests based on the users' request and the respective facts. The server comprises: (i) processor and (ii) a non-transitory computer-readable medium storing instructions. The processor, upon executing the instructions, is configured to: acquire dialogue data including (i) textual representations of human requests of dialogues of the users in a natural language; and (ii) textual representations of respective human answers of the dialogues, responsive to the human requests; acquire fact data including textual representations of facts; identify, from the fact data, using the semantic similarity ML model, for a given dialogue pair including textual representations of a given human request and a respective human answer responsive thereto from the dialogue data, the textual representation of a respective fact, which is relevant to at least one of the given human request and the respective human answer; generate a training set of data including a plurality of training digital objects, a given one of which includes: (i) the textual representation of the given human request; (ii) the textual representation of the respective fact; and (iii) a respective label being the textual representation of the respective human answer responsive to the given human request; feed the training set of data to the chatbot system, by: for the given training digital object of the plurality of training digital objects, feeding, by the processor, a concatenation of the textual representation of the given human request and the textual representation of the respective fact to the generative ML model to generate the textual representation of a respective machine-generated answer to the given human request given a context of the respective fact; and; and optimize a difference between the respective machine-generated answer and the respective human answer to the given human request, thereby training the chatbot system to generate the machine-generated answers to the users' requests.

In some implementations of the server, to identify the respective fact for the given dialogue pair of textual representations, using the semantic similarity ML model, the processor is configured to: feed each one of: (i) the textual representations of the human requests; (ii) the textual representations of the human answers; and (iii) the textual representations of the facts, to the semantic similarity ML model, to generate respective vector embeddings of each one of (i) the textual representations of the human requests; (ii) the textual representations of the human answers; and (iii) the textual representations of the facts; map the respective vector embeddings to a vector space; and identify the respective fact relevant to the at least one of the given human request and the respective human answer as being a fact associated with the respective vector embedding that is closest to the respective vector embedding of the at least one of the given human request and the respective human answer in the vector space.

In some implementations of the server, to identify the respective fact, the processor is further configured to apply a k-nearest neighbors algorithm.

In some implementations of the server, to identify the respective fact, the processor is further configured to apply a ranking function.

In some implementations of the server, to optimize the difference, the processor is configured to optimize a loss function representative of the difference between the respective machine-generated answer and the respective human answer.

In some implementations of the server, the processor is further configured to use the chatbot system for generating the machine-generated answers to the users' requests, by: receiving the textual representation of an in-use human request of a given user; identifying, from the fact data, using the semantic similarity ML model, the respective fact relevant to the in-use human request; and feeding, by the processor, a concatenation of the textual representations of the in-use human request and the respective fact to the generative ML model, thereby causing the generative ML model to generate the textual representation of a respective in-use machine-generated answer responsive to the in-use human request given the context of the respective fact.

In some implementations of the server, each one of the semantic similarity ML model and the generative ML model is a Transformer-based ML model.

In some implementations of the server, the generative ML model is devoid of an encoder portion of the Transformer-based ML model.

In some implementations of the server, the chatbot system is one of (i) a text-to-text chatbot system; (ii) text-to-speech chatbot system; (iii) a speech-to-text chatbot system; and (iv) a speech-to-speech chatbot system.

In the context of the present specific, a “transformer” model is a model having an encoder-decoder architecture that employs attention mechanisms. Attention mechanisms may be employed during processing of data by the encoder, during processing of data by the decoder, and during encoder-decoder interactions. A variety of attention mechanisms may be employed as part of a transformer model.

Self-attention may be one of the components of the transformer model. The difference between attention mechanism and self-attention mechanism is that self-attention operates between representations of the same nature: e.g., all encoder states in some layer.

Self-attention mechanism is a part of the transformer model where tokens interact with each other. Each token in a sense “looks” at other tokens in the sentence with an attention mechanism, gathers context, and updates the previous representation of “self”. Each input token in a self-attention mechanism receives three representations: (i) query, (ii) key, and (ii) value. The query is used when a token looks at others—it's seeking the information to understand itself better. The key is responding to a query's request: it is used to compute attention weights. The value is used to compute attention output: it gives information to the tokens which “say” they need it (i.e. assigned large weights to this token).

Masked self-attention may be another component of the transformer model. The decoder usually includes this particular self-attention mechanism, and which is different from the self-attention mechanism in the encoder. While the encoder receives all tokens at once and the tokens can look at all tokens in the input sentence, in the decoder, tokens are generated one at a time—during generation, the model does not know which tokens will be generated in future. To forbid the decoder to “look ahead”, the transformer model uses masked self-attention—i.e., future tokens are masked out.

Multi-head attention is a further one of the components of the transformer model. It should be noted that understanding the role of a word in a sentence requires understanding how it is related to different parts of the sentence. This is important not only in processing source sentence but also in generating targets. As a result, this type of attention mechanism may allow the transformer model to “focus of different things”. Instead of having one attention mechanism, multi-head attention has several “heads” which work independently. This may be implemented as several attention mechanisms whose results are combined.

The encoder of the transformer model can include an encoder self-attention mechanism and a feedforward network block. The encoder self-attention mechanism may be a multi-head attention mechanism used for tokens to “look” at each other. The queries, keys, values are computed from encoder states. The feedforward network block receives the information from tokens and processes that information.

The decoder of the transformer model can include a decoder self-attention mechanism (masked), a decoder-encoder attention mechanism, and a feedforward network. The decoder masked self-attention mechanism may be a masked multi-head attention mechanism used for tokens to “look” at previous tokens. The queries, keys, values are computed from decoder states. The decoder-encoder attention mechanism may be a multi-head attention mechanism used for target tokens to “look” at the source information. Queries are computed from decoder states, while keys and values are computed from encoder states. The feedforward network block receives the information from tokens and processes that information.

It can be said that in the encoder, tokens communicate with each other and update their representations. It can also be said that in the decoder, a target token first looks at previously generated target tokens, then at the source, and finally updates its representation. This can be repeated in several layers. In one non-limiting implementation, this can be repeated 6 times.

As mentioned above, in addition to an attention mechanism, a given layer has a feedforward network block. For example, the feedforward network block may be represented by two linear layers with a ReLU non-linearity between them. After looking at other tokens via an attention mechanism, a model uses a feedforward network block to process this new information. The transformer model may further comprise residual connections for adding a block's input to its output. Residual connections may be used for stacking layers. In a transformer model, residual connections can be used after a respective attention mechanism and feedforward network block. For example, an “Add & Norm” layer may be provided with (i) the input of an attention mechanism via a residual connection and (ii) the output of the attention mechanism. The result of this Add & Norm layer may then be provided to a feedforward network block or another attention mechanism. In another example, an “Add & Norm” layer may be provided with (i) the input of an feedforward network block via a residual connection and (ii) the output of the feedforward network block. As alluded to above, the transformer model may comprise Add & Norm layers. Broadly speaking, such a layer can independently normalize vector representation of each example in a batch—this is done to control “flow” to the next layer. Layer normalization may improve convergence stability and sometimes even quality.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. This information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an example computer system for implementing certain non-limiting embodiments of systems and/or methods of the present technology;

FIG. 2 depicts a networked computing environment suitable for some implementations of certain non-limiting embodiments the present technology;

FIG. 3 depicts a schematic diagram of a process for generating, by a chatbot system hosted by a server present in the networked computing environment of FIG. 2, a textual representation of a respective machine-generated answer to a given human request, in accordance with the non-limiting embodiments of the present technology;

FIG. 4 depicts a schematic diagram of a machine-learning model architecture suitable for use in some non-limiting implementations of the present technology;

FIG. 5 depicts a schematic diagram of a pre-training stage of training, by the server present in the networked computing environment of FIG. 2, a generative model of the chatbot system to generate the textual representation of the respective machine-generated answer to the given human request, in accordance withe certain non-limiting embodiments of the present technology;

FIG. 6 depicts a schematic diagram of a fine-tuning stage of training, by the server present in the networked computing environment of FIG. 2, the generative model of the chatbot system to generate the textual representation of the respective machine-generated answer, in accordance withe certain non-limiting embodiments of the present technology;

FIG. 7 depicts a schematic diagram of using, by the server present in the networked computing environment of FIG. 2, the generative model of the chatbot system to generate the textual representation of the respective machine-generated answer, in accordance withe certain non-limiting embodiments of the present technology; and

FIG. 8 depicts a flow chart of a method for training, by the server present in the networked computing environment of FIG. 2, chatbot system hosted thereby to generate the textual representation of the respective machine-generated answer, in accordance with the non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, and/or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and/or non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

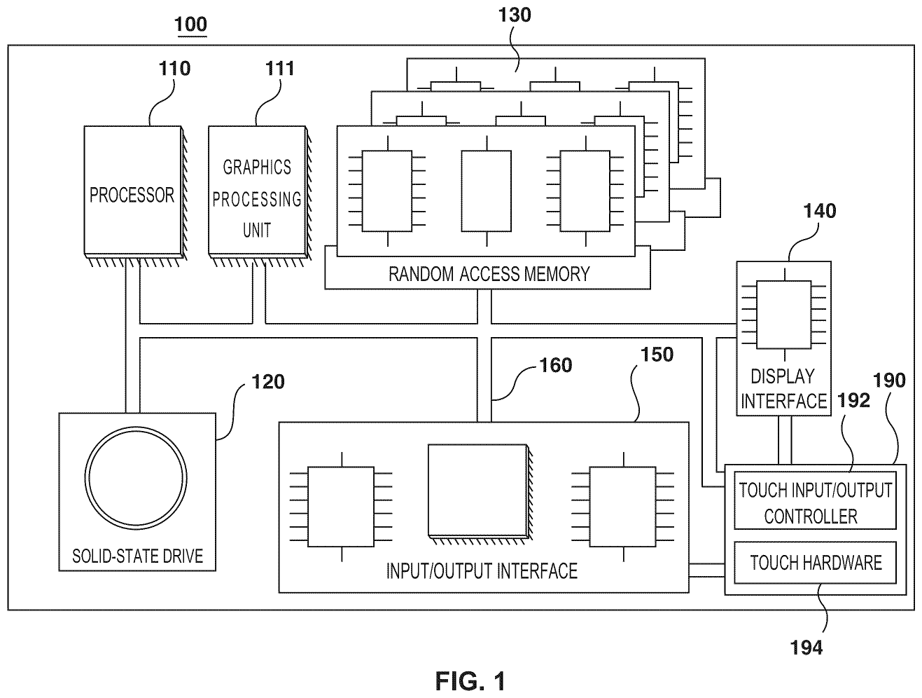

With reference to FIG. 1, there is depicted a computer system 100 suitable for use with some implementations of the present technology. The computer system 100 comprises various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some embodiments, the touchscreen 190 is the display. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190. In some embodiments, the computer system 100 may comprise one or more microphones (not shown). The microphones may record audio, such as user utterances. The user utterances may be translated to commands for controlling the computer system 100.

It is noted some components of the computer system 100 can be omitted in some non-limiting embodiments of the present technology. For example, the touchscreen 190 can be omitted, especially (but not limited to) where the computer system is implemented as a smart speaker device.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

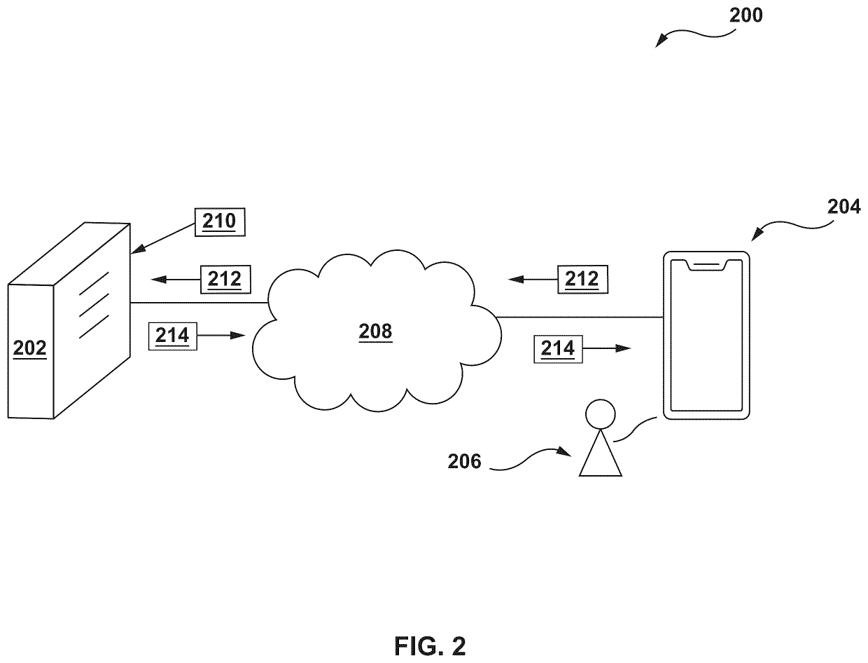

With reference to FIG. 2, there is depicted a schematic diagram of a networked computing environment 200 suitable for use with some embodiments of the systems and/or methods of the present technology. The networked computing environment 200 comprises a server 202 communicatively coupled, via a communication network 208, to an electronic device 204. In the non-limiting embodiments of the present technology, the electronic device 204 may be associated with a user 206.

In some non-limiting embodiments of the present technology, the server 202 is implemented as a conventional computer server and may comprise some or all of the components of the computer system 100 of FIG. 1. In one non-limiting example, the server 202 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 202 is a single server. In alternative non-limiting embodiments of the present technology (not depicted), the functionality of the server 202 may be distributed and may be implemented via multiple servers.

Further, the electronic device 204 may be any computer hardware that is capable of running a software appropriate to the relevant task at hand. Thus, some non-limiting examples of the electronic device 204 may include personal computers (desktops, laptops, netbooks, etc.), smartphones, and tablets. To that end, in some non-limiting embodiments of the present technology, the electronic device 204 can also comprise some or all components of the computer system 100 depicted in FIG. 1.

According to certain non-limiting embodiments of the present technology, the networked computing environment 200 can be configured for providing and/or maintaining an automatic communication with the user 206, as will be described hereinbelow. To that end, according to certain non-limiting embodiments of the present technology, the server 202 can be configured to execute a chatbot system 210 (also referred to herein as “virtual assistant application”).

Broadly speaking, the chatbot system 210 is configured for initiating and further maintaining an automatic communication with the user 206 aiding them in receiving various services provided by respective service providers. For example, in some non-limiting embodiments of the present technology, a given online service can comprise a video streaming platform (such as a Netflix™ video streaming platform, a Kinopoisk™ video streaming platform, and the like), and the chatbot system 210, via the automatic communication with the user 206, can be configured to aid the user 206 in searching through the content of the video streaming platform, for example, by providing content recommendations. In another example, the given online service can be a search engine (such as a Yandex™ search engine, a Google™ search engine, and the like); and the chatbot system 210 can be configured to assist the user 206 in web search to identify more relevant search results to queries submitted by the user 206. In yet other example, the given online service can be an online listing platform (such as a Yandex™ Market online listing platform, and Avito™ online listing platform, a Kijiji™ online listing platform, and the like); and the chatbot system 210 can be configured to assist the user 206 to in navigating through the items available for purchase at the online listing platform to identify items of interest. Also, in this example, the chatbot system 210 can be configured to implement certain customer service functionality, such as, taking and managing orders, process complains, and the like. In yet other non-limiting embodiments of the present technology, the given online service can be an internet banking application of a bank, and the chatbot system 210 can be configured to assist the user 206 in receiving certain banking services, such as conducting transactions, taking loans, making payments, and the like.

In some non-limiting embodiments of the present technology, an entity owning the chatbot system 210 and the given online service may be the same, and the given online service can be executed by the server 202. However, in other non-limiting embodiments of the present technology, the chatbot system 210 and the given online service can be owned by different entities; in this regard, the given online service can be executed by a third-party server (not depicted), which has access to the chatbot system 210 run by the server 202 via the communication network 208.

However, in some non-limiting embodiments of the present technology, the chatbot system 210 can be configured to assist the user 206 in receiving offline services. For example, a given offline service can be a restaurant; and the chatbot system 210 can be configured to aid the user 206 in booking tables or ordering food for delivery. In another example, the given offline service can be a bank, and the chatbot system 210 can be configured to assist the user 206 in receiving certain banking services, such as conducting transactions, taking loans, making payments, and the like.

In yet other non-limiting embodiments of the present technology, the chatbot system 210 can be a stand-alone chatbot system running on the electronic device 204. In these embodiments, the chatbot system 210 can be configured to operate independently from any of the above-mentioned services; however can help the user 206 navigate through various applications, pre-installed on the electronic device 204, that may be associated with some of the service mentioned above.

In specific non-limiting example, the chatbot system 210 may be implemented as an ALISA™ virtual assistant application provided by YANDEX LLC of 16 Lev Tolstoy Street, Moscow, 119021, Russia. However, it should be noted the chatbot system 210 can be implemented as any other commercial or proprietary virtual assistant application

In those embodiments where the chatbot system 210 is pre-installed on the electronic device 204, the user 206 can activate the chatbot system 210, for example, by a wake-up word associated with the chatbot system 210, such as “Hey, Siri” or “Privet Alisa”, for example. In other non-limiting embodiments of the present technology, the user 206 can activate the chatbot system 210 via a web browser application of the electronic device 204, by submitting thereto a URL associated with a browser version of the chatbot system 210. Further, the chatbot system 210 can be configured to: (i) receive an indication of a given human request 212 from the user 206; and in response thereto, (ii) generate a respective machine-generated answer 214, thereby maintaining the communication with the user 206.

It is not limited how the given human request 212 can be submitted to the chatbot system 210 and how the chatbot system 210 can further be configured to generate the respective machine-generated answer 214; and depends generally on a particular implementation of the chatbot system 210. For example, according to certain non-limiting embodiments of the present technology, the chatbot system 210 can be a text-to-text chatbot system, which is configured to receive textual representations (such as text strings) of human requests and generate textual representations of the respective machine-generated answers.

In other non-limiting embodiments of the present technology, the chatbot system 210 can be implemented as a voice-to-voice chatbot system, configured to receive the human requests in a form of human utterances and generate the respective machine-generated answers in a form of machine-generated utterances. In these embodiments, the chatbot system 210 can comprise: (i) a Speech-to-Text (STT) model (not depicted) configured to process spoken human language, such as a human utterance representative of the given human request 212, and recognize therein separate words, thereby generating a textual representation (such as a text string) of the given human request 212 for further processing; and (ii) a Text-to-Speech (TTS) model (not depicted) configured to convert machine-generated text, such as the textual representation of the respective machine-generated answer 214, to instances of natural language speech to be further played back a speaker of the electronic device 204. Needless to mention, in these embodiments, to enable the chatbot system 210 to receive human utterances, the electronic device 204 can include additional components, such as a microphone (not separately depicted) for converting received sounds captured in a vicinity of the electronic device 204 into a computer-readable format, such as digital audio format, including, for example, MP3, Ogg, and the like; and a speaker (also not separately depicted) for reproducing incoming audio signals in the vicinity of the electronic device 204. Also, for reproducing the machine-generated utterances generated by the TTS model, the electronic device 204 can include a speaker.

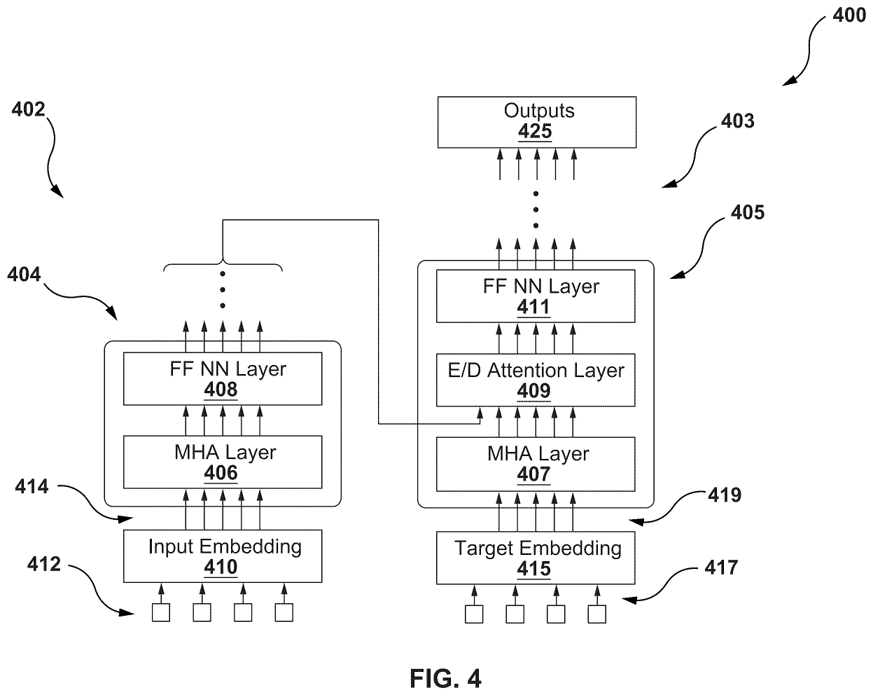

It is not limited how the STT and TTS models are implemented. In some non-limiting embodiments of the present technology, each one of the STT and TTS models can be implemented as Transformer-based neural networks (NN), such as a machine-learning model architecture 400 described herein below with reference to FIG. 4. In these embodiments, the STT and TTS models can be trained for further use with the chatbot system 210 as described, for example, in a co-owned U.S. patent application Ser. No. 18/081,634, filed on Dec. 14, 2022, and entitled “METHOD AND SYSTEM FOR RECOGNIZING A USER UTTERANCE”, the content of which is incorporated herein by reference in its entirety.

Hybrid implementations of the chatbot system 210, such as text-to-voice and voice-to-text are also envisioned without departing from the scope of the present technology.

Thus, in some non-limiting embodiments of the present technology, the chatbot system 210 can be configured to receive the textual representation of the given human request 212 reading, for example, “Please recommend a good sci-fi movie”. Further, the chatbot system 210 can be configured to generate the textual representation of the respective machine-generated answer 214 reading, for example: “This is what I have found for your request”, along with which the chatbot system 210 can be configured to retrieve a list of recommendable sci-fi movies, identified, for example, by a search engine or a video streaming platform. Further, the server 202 can be configured to transmit the textual representation of respective machine-generated answer 214 along with the list of recommendable sci-fi movies to the electronic device 204 for presentation to the user 206.

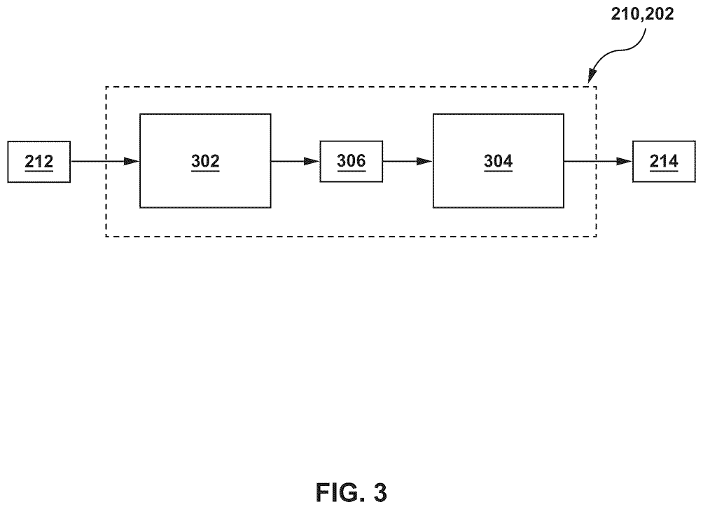

With reference to FIG. 3, there is depicted a schematic diagram of a process for generating, by the server 202 running the chatbot system 210, the respective machine-generated answer 214 to the given human request 212, in accordance with certain non-limiting embodiments of the present technology.

According to certain non-limiting embodiments of the present technology, the chatbot system 210 can comprise an embedding model 302 configured to generate vector embeddings of textual representations of user requests, such as a respective vector embedding 306 of the given human request 212. Detailed description of the embedding model 302 will be provided below; however, broadly speaking, the embedding model 302 is configured to factorise textual inputs, such as words, sentences, or paragraphs, for example, into numerical vectors of a given vector embedding space such that vector embeddings of semantically similar textual inputs, that is those closer in meanings, are located, in the given vector embedding space, closer to each other than those that are semantically dissimilar, that is, being having different meanings. To that end, the embedding model 302 is also referred to herein as a “semantic similarity model”.

Further, according to certain non-limiting embodiments of the present technology, the chatbot system 210 can comprise a generative model 304 configured to generate, based on the respective vector embedding 306 of the given human request 212, the textual representation of the respective machine-generated answer 214.

Broadly speaking, the generative model 304 is an machine-learning model (such as Deep Neural Network-based machine-learning model) that has been trained to generate textual representations of machine-generated answers to user requests based on a training set of data including textual representations of a plurality of training dialogue pairs, including (i) training user requests; and (ii) respective training responses thereto in a natural language, such as Russian or English, for example.

For example, the server 202 can be configured to obtain such dialogue pairs of “requests-answers” for the training set of data by crawling various resources of the communication network 208 providing access to public domain conversations of humans, such as comments or posts on a given social network website or discussions on a given forum website. In another example, the server 202 can be configured to obtain these natural language dialogue pairs from offline service providers, which may include dialogue lines between employees, such as representatives of the customer service department, of the service providers and their clients.

However, as mentioned above, generative machine-learning models, trained solely on the dialogue pairs “requests-answers” tend to provide machine-generated answers that can be perceived by the users of the chatbot system 210, such as the user 206, as being uninteresting (or otherwise “flat”) or irrelevant to a time the user 206 submits the given human request 212 to the chatbot system 210, which may affect the overall user experience of the user 206 with the chatbot system 210.

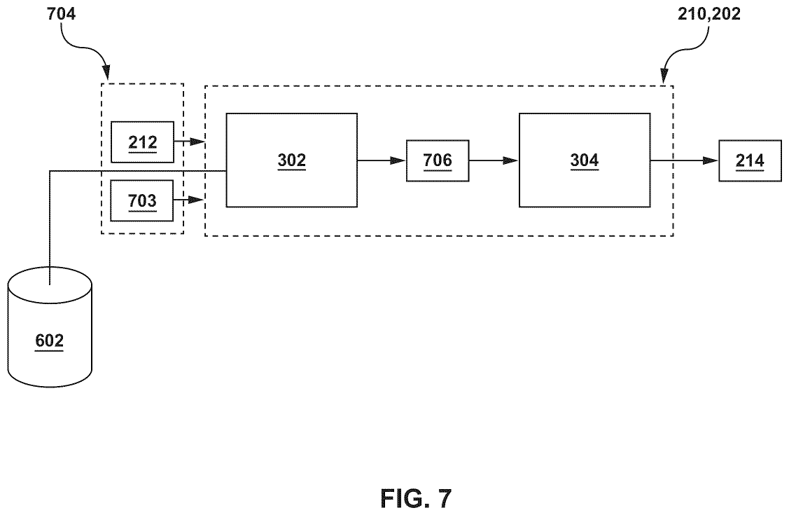

In this regard, the developers of the present technology have realised that adding factual context to each of the dialogue pairs may enable training of the generative model 304 to generate more natural and diverse machine-generated answers to the user requests. More specifically, the present methods and systems are directed to training the chatbot system 210 to generate the textual representations of respective augmented machine-generated answers to the user requests, such as a respective augmented machine-generated answer 714 to the given human request 212 (as will be described in detail with reference to FIG. 7), considering the context of respective facts that have been identified as being relevant to the user requests.

Example architecture, as well as how the server 202 can be configured to train the embedding and generative models 302, 304 to generate the textual representation of the respective augmented machine-generated answer 714 to the given human request 212, in accordance with certain non-limiting embodiments of the present technology, will be described in detail below with reference to FIGS. 4 to 7.

### Communication Network

In some non-limiting embodiments of the present technology, the communication network 208 is the Internet. In alternative non-limiting embodiments of the present technology, the communication network 208 can be implemented as any suitable local area network (LAN), wide area network (WAN), a private communication network or the like. It should be expressly understood that implementations for the communication network 208 are for illustrative purposes only. How a respective communication link (not separately numbered) between each one of the server 202, the electronic device 204, and the communication network 208 is implemented will depend, inter alia, on how each one of the server 202 and the electronic device 204 is implemented. Merely as an example and not as a limitation, in those embodiments of the present technology where the electronic device 204 is implemented as a wireless communication device such as a smartphone, the communication link can be implemented as a wireless communication link. Examples of wireless communication links include, but are not limited to, a 3G communication network link, a 4G communication network link, and the like. The communication network 208 may also use a wireless connection with the server 202.

### Machine-Learning Model Architecture

With reference to FIG. 4, there is depicted a machine-learning model architecture 400 suitable for use with at least some non-limiting embodiments of the present technology. The machine-learning model architecture 400 is based on a Transformer neural network model architecture as described, for example, in an article by Vaswani et al. “Attention Is All You Need,” and published in the Proceedings of 31^{st} Conference on Neural Information Processing Systems (NIPS 2017), the content of which is incorporated herein by reference in its entirety.

Thus, the machine-learning model architecture 400 can comprise an encoder stack of layers 402 and a decoder stack of layers 403, which can be configured to process the input data 412 and target data 417 of the machine-learning model architecture 400, respectively.

Further, a given encoder block 404 of the encoder stack of layers 402 includes an encoder multi-head attention (MHA) layer 406 and an encoder feed-forward NN layer 408. The encoder MHA layer 406 includes dependencies between portions of the input data 412 provided thereto. For example, if the input data 412 includes text data, such as a text sentence, the encoder MHA layer 406 may include dependencies between words of the sentence. In another example, where the input data 412 to the encoder stack of layers 402 includes an audio signal, such as that representing a human utterance, the encoder MHA layer 406 may include dependencies between certain sounds and/or acoustic features of the human utterance. Such dependencies can be used by the encoder MHA layer 406 for determining contextual information of a given portion of the input data 412 to the encoder stack of layers 402 (such as that representative of a given word of the sentence) relative to another portion of the input data 412.

Further, the encoder feed-forward NN layer 408 is configured to transform data input thereto from the encoder MHA layer 406 into a format receivable by one or more following layers of the machine-learning model architecture 400, such as an encoder-decoder MHA layer 409, as will be described below. The encoder feed-forward NN layer 408 generally lacks dependencies of the encoder MHA layer 406, and thus the inputs to the encoder feed-forward NN layer 408 may be processed in parallel.

Further, the input data 412 to the encoder stack of layers 402 can be represented by a plurality of input vectors 414 generated by an input embedding algorithm 410. Generally speaking, the input embedding algorithm 410 is configured to generate fixed-dimensional vector embeddings of the input data 412 in a respective vector embedding space. In other words, if the input data 412 comprise text data, such as a text sentence, the input embedding algorithm 410 can be configured to generate the plurality of input vectors 414, where coordinates of vector embeddings representative of words of the text sentence similar in meaning are positioned closer to each other in the respective embedding space. Thus, the input embedding algorithm 410 can be implemented as a text embedding algorithm including, without limitation, one of a Word2Vec text embedding algorithm, a GloVe text embedding algorithm, and the like.

Thus, a given one of the plurality of input vectors 414 can include numerical values, such as 768 floating point values, as an example, representative of a respective portion of the input data 412, such as a word, a portion of the given human request 212, and the like.

Also, the generating the plurality of input vectors 414 can further include applying a positional embedding algorithm (not depicted) configured to register positional information within portions of the input data 412. For example, if the input data 412 includes a text sentence, the positional embedding algorithm can be configured to generate a vector indicative of positional information amongst words in that text sentence. In other words, the positional embedding algorithm can be configured to generate the vector retaining contextual information within the input data 412, which can further be added to the plurality of input vectors 414. It is not limited how the positional embedding algorithm is implemented; and may include, without limitation, a sinusoid positional embedding algorithm, a frame stacking positional embedding algorithm, and a convolutional positional embedding algorithm, as an example.

It should be noted that the encoder stack of layers 402 can include multiple encoder blocks, such as 6 or 12, for example, implemented similarly to the given encoder block 404.

Further, a given decoder block 405 of the decoder stack of layers 403 of the machine-learning model architecture 400 also includes (i) a decoder MHA layer 407; and (ii) a decoder feed-forward NN layer 411, which can generally be implemented in a similar fashion to the encoder MHA layer 406 and the encoder feed-forward NN layer 408, respectively. However, the architecture of the given decoder block 405 differs from that of the given encoder block 404 in that that the given decoder block 405 additionally includes the encoder-decoder MHA layer 409. The encoder-decoder MHA layer 409 is configured to (i) receive input vectors from the encoder stack of layers 402 and from the decoder MHA layer 407; and thus (ii) determine, during a training process dependencies between the input data 412 and the target data 417 (such as text data, for example) of the machine-learning model architecture 400 input to the decoder stack of layers 403. In other words, outputs of the encoder-decoder MHA layer 409 are attention vectors including data indicative of relationships between respective portions of the input data 412 and the target data 417.

Similar to the input data 412, for feeding the target data 417 to the given decoder block 405, a target embedding algorithm 415 can be applied to the target data 417 for generating a plurality of target vectors 419 comprising numerical representations of respective portions of the target data 417.

As it can be appreciated, in those embodiments where the target data 417 is the text data, the target embedding algorithm 415 can be implemented in a similar fashion to the input embedding algorithm 410. Additionally, the positional algorithm can also be applied to the plurality of target vectors 419 for registering positional data amongst portions of the target data 417, as described above with respect to the plurality of input vectors 414.

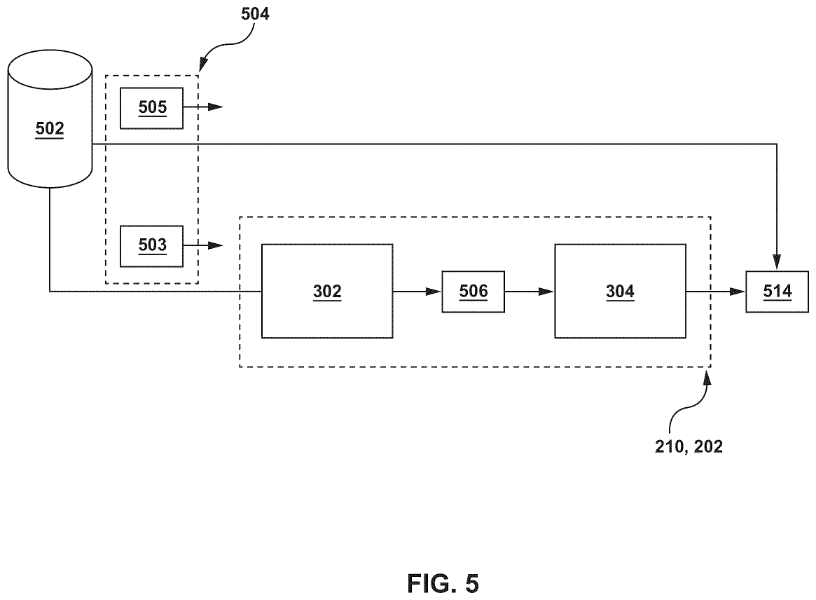

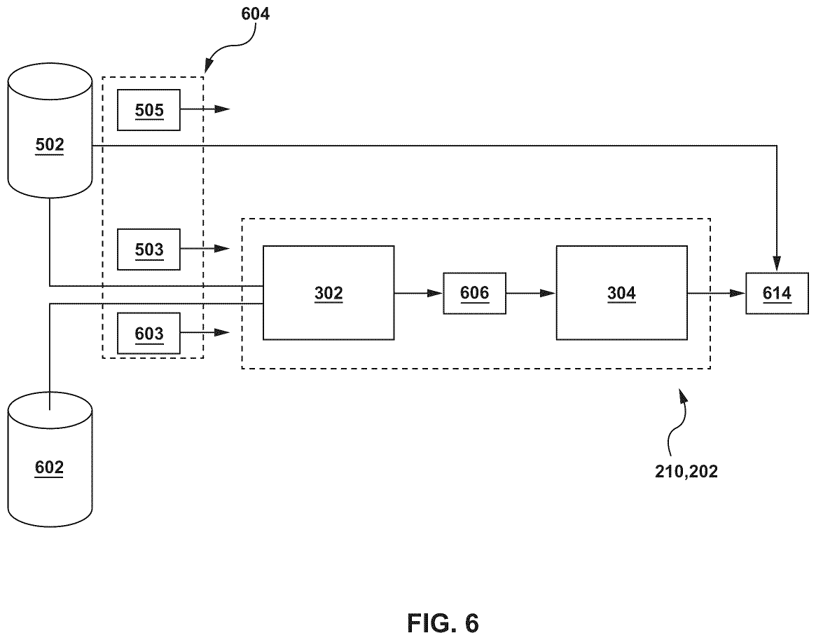

As will become apparent from the description provided hereinbelow, the machine-learning model architecture 400 can be configured to receive the input data 412 and the target data 417 from a digital object, such as one of a given training digital object 504 or and a given other training digital object 604 as will be described with reference to FIGS. 5 and 6, respectively.

Similarly, it should be noted that the decoder stack of layers 403 can include multiple decoder blocks, such as 6 or 12, for example, implemented similarly to the given decoder block 405. Also, as it can be appreciated, after the training the machine-learning model architecture 400, each block of the encoder stack of layers 402 and the decoder stack of layers 403 will have different weights contributing to the generation of the output data 425. For adjusting the weights during the training process, a backpropagation algorithm can be applied to the machine-learning model architecture 400, and a difference between the input data 412 and the output data 425 can be determined and further optimized. Such difference can be expressed by a loss function, such as a Cross-Entropy Loss Function.

It should be expressly understood that other implementations of the loss function are also envisioned by the non-limiting embodiments of the present technology and may include, by way of example, and not as a limitation, a Mean Squared Error Loss function, a Huber Loss function, a Hinge Loss function, and others.

Also, it is not limited how the server 202 can be configured to optimize the loss function, and in some non-limiting embodiments of the present technology, will depend generally on the differentiability of the loss function. For example, if the loss function is continuously differentiable, approaches to minimizing it can include, without limitation, a Gradient Descent algorithm, a Newton's optimization algorithm, and others. In those embodiments where the loss function is non-differentiable, to minimize it, the server 202 can be configured to apply at least one of a Direct algorithms, Stochastic algorithms, and Population algorithms, as an example.

The output data 425 of the machine-learning model architecture 400 can include an output vector corresponding to a given one of the plurality of input vectors 414 and/or the plurality of target vectors 419. For example, as will become apparent from the description below, in those embodiments, where the input data 412 to the machine-learning model architecture 400 includes the textual representation of the given human request 212, the output vector can include probabilities indicative of the textual representation of the respective augmented machine-generated answer 714.

It will be understood that the architecture of the machine-learning model architecture 400 described with reference to FIG. 4 has been greatly simplified for ease of understanding; and an actual implementation of the machine-learning model architecture 400 may include additional layers and/or blocks, as described, for example, in the Vaswani et al. article referenced above. For example, in some implementations of the machine-learning model architecture 400, each of the given encoder block 404 and the given decoder block 405 may also include layer normalization operations. Additionally, generating the output data 425 may include applying a softmax normalization function at an output of the decoder stack of layers 403, and so on. One of ordinary skill in the art would understand that these operations are commonly used in neural networks and deep learning models such the machine-learning model architecture 400.

### Embedding Model

As mentioned hereinabove, the embedding model 302 can be configured to generate vector embeddings of text input thereto, such as those of textual representations of the user requests, in the respective vector embedding space. According to certain non-limiting embodiments of the present technology, the embedding model 302 can be implemented as the text embedding algorithm, such as one of the input and target embedding algorithms 410, 415 described above.

However, in other non-limiting embodiments of the present technology, the embedding model 302 can be an independent machine-learning model, which the server 202 can be configured to train to generate the respective text vector embeddings. For example, in some non-limiting embodiments of the present technology, the embedding model 302 can be implemented based on long short-term memory (LSTM) neural network (NN), as escribe, for example, in an article authored by Chang et al., entitled “Expectation—Regulated Neural Model for Event Mention Extraction”, and published by the Singapore University of Technology and Design in June 2016, the content of which is incorporated herein by reference in int entirety.

In another example, the embedding model 302 can be implemented based on the machine-learning model architecture 400 described above. In some non-limiting embodiments of the present technology, the embedding model 302 can include only the encoder stack of layers 402, that is, devoid of any decoder blocks, having, for example, 12, 24, or 36 encoder blocks implemented similarly to the given encoder block 404 described above. In this case, the embedding model 302 can be referred to as a Bidirectional Encoder Representations from Transformers (BERT) model.

In these embodiments, first, the server 202 can be configured to pre-train the embedding model 302 using a masked language modelling (MLM) objective. More specifically, the MLM objective is based on one of two unsupervised learning objectives used in BERT, which is used to learn text representations from collections of unlabeled documents. These documents can include a plurality of text documents from the public domain, such as tens of thousands or hundreds of thousands, or even millions of various text documents.

Further, to pre-train with the MLM objective, the server 202 can be configured to: (i) tokenize text in each of the text documents in the input data 412 to the embedding model 302, using, for example, a pre-built vocabulary of tokens; (ii) using token indices in the pre-built vocabulary of tokens, generate, for each text unit, such as a sentence or a paragraph, a respective instance of the plurality of input vectors 414; (ii) mask, in a given vector of the respective instance of the plurality of input vectors 414, one or more tokens by replacing them with a special [MASK] token. In some non-limiting embodiments of the present technology, the server 202 can be configured to determine the pre-built vocabulary of tokens using a WordPiece byte-pair encoding scheme used in BERT with a sufficiently large vocabulary size. For example, in some implementations, the vocabulary size may be approximately 120,000 tokens. In some implementations, there may be preprocessing of the text, such as converting all words to lowercase and performing Unicode NFC normalization. A WordPiece byte-pair encoding scheme that may be used in some implementations to build the token vocabulary is described, for example, in Rico Sennrich et al., “Neural Machine Translation of Rare Words with Subword Units”, Proceedings of the 54th Annual Meeting of the Association for Computational Linguistics (Volume 1: Long Papers), pages 1715-1725, 2016.

Further, the server 202 can be configured to feed the plurality of input vectors 414 having masked tokens to the embedding model 302, thereby training the embedding model 302 to predict the probabilities of a given masked token corresponding to tokens in the pre-built vocabulary of tokens. This is done based on the output data 425 (which is a vector) of the last layer of the embedding model 302 that correspond to the masked tokens. More specifically, during the pre-training, the server 202 can be configured to optimize a difference between the actual masked tokens (i.e., the “ground truth”) and the predicted probabilities. This difference can be expressed by a loss function (such as the cross-entropy loss function mentioned above). By doing so, the server 202 can be configured to adjust the weights in embedding model 302 to reduce the loss.

It should be expressly understood that, in other non-limiting embodiments of the present technology, the embedding model 302 can be pre-trained as described above by a third-party server, to which the server 202 can further be provided with access for using the embedding model 302.

Further, the server 202 can be configured to use the embedding model 302 to generate the respective vector embeddings of the input text, such as the respective vector embedding 306 of the textual representation of the given human request 212. More specifically, the server 202 can be configured to generate the respective vector embedding 306 as outputs of hidden encoder blocks of the encoder stack of layers 402 of the embedding model 302 pre-trained as described above. For example, in certain non-limiting embodiments of the present technology, the server 202 can be configured to generate the respective vector embedding 306 as concatenated outputs of a predetermined number (such as sixth, four, or two, as an example) of outer encoder blocks of the embedding model 302, each of which can comprise, in certain implementations, a vector of 768 floating point values in length, as mentioned above.

Thus, the embedding model 302 can be trained to generate the respective vector embeddings of the input text, such that the vector embeddings associated with text units that are similar in meaning would be closer to each other in the respective vector embedding space; whereas the respective vector embeddings associated with text units that are not close in meaning, that is, semantically dissimilar, would be farther from each other in the respective embedding space.

Further, the server 202 can be configured to use the embedding model 302 to generate the respective vector embeddings for the generative model 304, such as the respective vector embedding 306 of the given human request 212, based on which the generative model 304 may be configured to generate the textual representation of the respective augmented machine-generated answer 714.

### Generative Model

As mentioned hereinabove, according to certain non-limiting embodiments of the present technology, the generative model 304 of the chatbot system 210 can be configured to generate, based on the respective vector embedding 306 of the textual representation of the given human request 212, the textual representation of the respective augmented machine-generated answer 714 to be further provided to the user 206.

The respective augmented machine-generated answer 714 can be indicative, for example, of a next conversation line of the chatbot system 210, responsive to the given human request 212. For example, if the given human request 212 reads “Hey! I would like to watch a good cartoon”, the respective augmented machine-generated answer 714 can be indicative of the following phrase: “Sure! Check out “Pinocchio” by Guillermo del Toro. It's one of the most popular ones now”.

In some non-limiting embodiments of the present technology, the generative model 304 can be implemented based on a neural network (NN), such as a LSTM NN or a recurrent NN. However, according to certain non-limiting embodiments of the present technology, the generative model 304 can be implemented as a Transformer-based NN model. To that end, the generative model 304 can include some or all the components of the machine-learning model architecture 400 described above.

For example, in some non-limiting embodiments of the present technology, the generative model 304 can include one encoder block and thirteen decoder blocks implemented similarly to the given encoder block 404 and the given decoder block 405, respectively, as described above. In other non-limiting embodiments of the present technology, the generative model 304 can include no encoder blocks and multiple decoder blocks, such as 6, 12, or 96, as an example, in which case the generative model 304 can be referred to as a Generative Pre-trained Transformer (GPT) model. By contrast, in yet other non-limiting embodiments of the present technology, the generative model 304 can include only encoder blocks, such as 12, 24, or 36, as an example, and no decoder blocks, in which case, akin to the embedding model 302, the generative model 304 can be referred to as a BERT model.

Other configurations of the encoder stack of layers 402 and the decoder stack of layers 403 for implementing the generative model 304 are also envisioned without departing from the scope of the present technology.

Also, as noted hereinabove, instead of the at least one of the input embedding algorithm 410 and the target embedding algorithm 415, for generating input and target pluralities of input and target vectors 414, 419 to the generative model 304, in some non-limiting embodiments of the present technology, the server 202 can be configured to use the embedding model 302 trained as described above.

Overall, according to certain non-limiting embodiments of the present technology, the server 202 can be configured to execute two respective processes in respect of generative model 304. A first process of the two processes is a training process, where the server 202 is configured to train the generative model 304, based on a training set of data, to generate the textual representation of the respective augmented machine-generated answer 714, which will be discussed below. A second process is an in-use process, where the server 202 is configured to apply the so-trained generative model 304 to input textual representations will be described, in accordance with certain non-limiting embodiments of the present technology, further below.

### Training Process

According to certain non-limiting embodiments of the present technology, the server 202 can be configured to train the generative model 304 to generate the respective machine-generated answers in two stages. During a first training stage, also referred to as a “pre-training” stage, the server 202 can be configured to train the generative model 304 to generate the textual representation of the respective augmented machine-generated answer 714 to the given human request 212 based on training dialogue pairs “request-answer” in the natural language.

Further, during a second training stage, following the first one, which is also referred to as a “fine-tuning” stage, along with the training dialogue pairs, the server 202 can also be configured to use factual data, providing context to respective training dialogue pairs. By doing so, the server 202 can be configured to train the generative model 304 to generate the textual representations of more natural and diverse machine-generated answers to the user requests.

With reference to FIG. 5, there is depicted a schematic diagram of the first training stage of training, by the server 202, the generative model 304 to generate the respective augmented machine-generated answer 714 to the given human request 212, in accordance with certain non-limiting embodiments of the present technology.

In some non-limiting embodiments of the present technology, the server 202 can be configured to host (or otherwise have remote access to via the communication network 208) a dialogue database 502 configured to store dialogue data. According to certain non-limiting embodiments of the present technology, the dialogue data stores textual representations of a plurality of training dialogue pairs produced in the natural language, such as by human users. Thus, a given training dialogue pair of the plurality of training dialogue pairs stored in the dialogue database 502 can include: (i) the textual representation of a given training human request 503 (such as “Hey, have you already watched the new Avatar? The video effects are beyond amazing!”); and (ii) the textual representation of a respective training human answer 505, responsive to the given training human request 503 (reading, for example: “Stop! Don't spoil—going to the cinema tonight”).

It is not limited how the server 202 can be configured to populate the dialogue database 502. For example, in some non-limiting embodiments of the present technology, the server 202 can be configured to crawl the web resources of the communication network 208 including public domain conversations, which may include, without limitation: (i) dialogue lines from publicly available literature; (ii) dialogue lines formed by user comments on social networks (such as a VK.COM™ social network); (iii) dialogue lines formed by user reviews left on at least one of audio streaming platforms, video streaming platforms, and online listing platforms; (iv) dialogue lines formed by forum discussions; (v) dialogue lines from recording of telephone conversations between various service providers and their customers; and the like. However, in other non-limiting embodiments of the present technology, the dialogue database 502 can be prepopulated by a third-party server (not depicted) without departing from the scope if the present technology.

Thus, for training the generative model 304 during the first training stage, the server 202 can be configured to generate a first plurality of training digital objects, a given training digital object 504 of which includes: (i) the textual representation of the given training human request 503; and (ii) a respective label being the textual representation of the respective training human answer 505. Further, the server 202 can be configured to feed each one of the first plurality of training digital objects to the generative model 304 without introducing thereto respective labels of the training digital objects. In other words, when feeding to the generative model 304 the given training digital object 504, in some non-limiting embodiments of the present technology, the server 202 can be configured to feed only the given training human request 503 (without feeding thereto the textual representation of the respective training human answer 505), thereby causing the generative model 304 to generate the textual representation of a respective training machine-generated answer 514. As noted hereinabove, to feed the given training human request 503 to the generative model 304, the server 202 can be configured to apply thereto the embedding model 302 trained as described above, thereby generating a respective training vector embedding 506, for further feeding to the generative model 304.

Further, the server 202 can be configured to optimize a difference between the respective training machine-generated answer 514 and the respective training human answer 505, which can be expressed by the loss function, examples of and approaches to optimizing which are non-exhaustively listed above. Further, using the backpropagation algorithm, at each training iteration, the server 202 can be configured to adjust the weights of the generative model 304, thereby pre-training the generative model 304 to generate the textual representation of the respective augmented machine-generated answer 714 to the given human request 212. Further, the server 202 can be configured to fine-tune the generative model 304 to generate the textual representation of the respective augmented machine-generated answer 714.

With reference to FIG. 6, there is depicted a schematic diagram of the second training stage of training, by the server 202, the generative model 304 to generate the respective augmented machine-generated answer 714 to the given human request 212, in accordance with certain non-limiting embodiments of the present technology.

As mentioned hereinabove, during the second training stage, according to certain non-limiting embodiments of the present technology, along with the training dialogue pairs, the server 202 can be configured to use certain factual data. To that end, according to certain non-limiting embodiments of the present technology, the server 202 can be configured to host (or otherwise have remote access to) a fact database 602 configured to store fact data, including textual representations of various facts. The nature of these facts is not limited. For example, certain facts can be indicative of common knowledge, such as “The Earth is round”, “COVID-19 is a disease caused by the SARS-CoV-2 coronavirus“, “Moscow is the capital of Russia”, and the like. However, in some non-limiting embodiments of the present technology, the fact database 602 can include the textual representations of facts specific to certain industries, such as the film industry, the law industry, the fast-moving customer goods (FMCG) industry, and the like. In this regard, a given entry of the fact database 602 can read “Avatar-2 earned more than $134 million worldwide on the opening weekend”, “Meryl Streep has won three Academy Awards”, “On Feb. 28, 2023, the show “Cunk on Earth” was rated 8.1 on IMDB”, and the like.

It is not limited how the fact database 602 can be populated. In some non-limiting embodiments of the present technology, the server 202 can be configured to populate the fact database 602 by crawling various resource of the communication network 208. For example, the server 202 can be configured to crawl certain reference resources (such as a Wikipedia™ online encyclopedia, a Britannica™ online encyclopedia, and the like), online news portals (such as a Yandex.News™ online news portal, a Rambler™ online news portal, and the like), or reference and news pages of at least one of the online listing platforms, the audio streaming platforms, and the video streaming platforms. Also, in other non-limiting embodiments of the present technology, the fact database 602 can be prepopulated by the third-party server without and made accessible by the server 202, without departing from the scope of the present technology.

Additionally, in some non-limiting embodiments of the present technology, the fact database 602 can be updated from time to time, for example, regularly (once a day, once a week, once a month, and the like) so that the facts stored in the fact database 602 are up-to-date.

Further, based on the dialogue data from the dialogue database 502 and the fact data from the fact database 602, the server 202 can be configured to generate a second plurality of training digital objects, a given other training digital object 604 of which includes: (i) the textual representation of the given training human request 503; (ii) the textual representation of a respective training fact 603 from the fact database 602; and (iii) the respective label being the textual representation of the respective training human answer 505.

In some non-limiting embodiments of the present technology, the second plurality of training digital objects can include training dialogue pairs that are different from those used for generating the first plurality of training digital objects. In other non-limiting embodiments of the present technology, the second plurality of training digital objects can include training dialogue pairs that at least partially coincide with those used for generating the first plurality of training digital objects. In some non-limiting embodiments of the present technology, a number of members in the second plurality of training digital objects can be equal to that of the first plurality of training digital objects. In other non-limiting embodiments of the present technology, a number of members in the second plurality of training digital objects can be different from that of the first plurality of training digital objects, such as smaller. By way of example only, in those embodiments where the number of members in the first plurality of training digital objects is around 600 million, the number of members of the second plurality of training digital objects can be around 30, 40, or even 200 or 500 thousand.

According to certain non-limiting embodiments of the present technology, the server 202 can be configured to identify the respective training fact 603 as being relevant to at least one of given training human request 503 and the respective training human answer 505. To that end, in some non-limiting embodiments of the present technology, the server 202 can be configured to: (i) feed the textual representations of each dialogue pair from the dialogue database 502 and the textual representations of the facts from the fact database 602 to the embedding model 302 to generate respective vector embeddings in the respective vector embedding space; and (ii) determine the respective training fact 603 as that associated with the respective vector embedding which is closest to the respective vector embeddings of the at least one of the given training human request 503 and the respective training human answer 505 in the respective vector embedding space.

To determine the respective vector embedding associated with the respective training fact 603, which is closest to the respective vector embeddings of the at least one of the given training human request 503 and the respective training human answer 505, in some non-limiting embodiments of the present technology, the server 202 can be configured to apply a K-nearest neighbors algorithm, which is configured to identify a K number of nearest neighbors of vector embeddings around a given one, such as that of the at least one of the given training human request 503 and the respective training human answer 505. A value of K can be predetermined, for example, by an operator of the chatbot system 210, and comprise 3, 5, or 10, as an example.

However, in other non-limiting embodiments of the present technology, instead of or in addition to the K-nearest neighbors algorithm, to identify the respective vector embedding associated with the respective training fact 603, which is relevant to the respective vector embeddings of the at least one of the given training human request 503 and the respective training human answer 505, in some non-limiting embodiments of the present technology, the server 202 can be configured to apply a heuristic algorithm, such as a ranking function. Broadly speaking, the ranking function is configured to determine relevant search quires (the respective training fact 603) to respective search queries (the at least one of the given training human request 503 and the respective training human answer 505) based on a term frequency-inverse document frequency (TF-IDF) statistic. For example, in some non-limiting embodiments of the present technology, the ranking function can comprise one of Okapi BM25 and BM25+ ranking functions.

Further, after identifying, from the fact database 602, respective training facts for each one of the dialogue pairs in the second plurality of training digital objects, as described above, the server 202 can be configured to feed each one of the second plurality of training digital objects to the generative model 304, thereby fine-tuning the generative model 304 to generate the textual representations of respective augmented machine-generated answers to the user requests of users of the chatbot system 210. More specifically, in this regard, the server 202 can be configured to: (i) for each one of the second plurality of training digital objects, such as the given other training digital object 604, generate a concatenation of the textual representations of the given training human request 503 and the respective training fact 603 identified using the embedding model 302; and (ii) feed the concatenation of the textual representations of the given training human request 503 and the respective training fact 603 to the generative model 304, thereby causing the generative model 304 to generate a respective other training machine-generated answer 614.

In some non-limiting embodiments of the present technology, the server 202 can be configured to generate the concatenation of the textual representations of the given training human request 503 and the respective training fact 603 by generating a concatenation of the respective vector embeddings thereof generated, for example, by the embedding model 302 as described above. More specifically, in these embodiments, the server 202 can be configured to: (i) generate, based on the respective vector embeddings of the given training human request 503 and the respective training fact 603, a respective training concatenated vector embedding 606; and (ii) feed the respective training concatenated vector embedding 606 to the generative model 304, thereby causing the generative model 304 to generate the respective other training machine-generated answer 614.

Further, akin to the first training stage, the server 202 can be configured to optimize the difference between the respective other training machine-generated answer 614 and the respective label, which is the respective training human answer 505, as described above. By doing so, the server 202 can be configured to fine-tune the generative model 304 to generate the textual representations of the respective augmented machine-generated answers to the user requests considering contexts provided by respective facts, determined as being relevant to the user requests.

Further, the server 202 can be configured to use the generative model 304 pre-trained and fine-tuned as described above to generate the textual representations of respective augmented machine-generated answers to the user requests submitted to the chatbot system 210, which will be described immediately below with reference to FIG. 7.

### In-use Process

With reference to FIG. 7, there is depicted a schematic diagram of the in-use process for using, by the server 202, both the embedding and generative models 302, 304 to generate the textual representation of the respective augmented machine-generated answer 714 to the given human request 212, in accordance with certain non-limiting embodiments of the present technology.

According to certain non-limiting embodiments of the present technology, during the in-use process, the server 202 can be configured to: (i) receive the textual representation of the given human request 212; (ii) based on the given human request 212, identify, in the fact database 602, the textual representation of a respective in-use fact 703, relevant to the given human request 212, using the respective vector embeddings thereof generated by the embedding model 302 as described above with respect to the respective training fact 603; (iii) generate a concatenation of the textual representations of the given human request 212 and the respective in-use fact 703; (iv) feed the concatenation of the textual representations of the given human request 212 and the respective in-use fact 703 to the generative model 304, thereby causing the generative model 304 to generate the textual representation of the respective augmented machine-generated answer 714 to the given human request 212.

However, in those embodiments where the server 202 is configured to train the generative model 304 based on concatenations of the respective vector embeddings associated with training human requests and respective training facts; during the in-use process, in some non-limiting embodiments of the present technology, for generating the concatenation of the textual representations of the given human request 212 and the respective in-use fact 703, the server 202 can similarly be configured to generate a concatenation of the respective vector embeddings thereof generated, for example, by the embedding model 302 as described above. More specifically, in these embodiments, the server 202 can be configured to: (i) feed the textual representations of each one of the given human request 212 and the respective in-use fact 703 to the embedding model 302 to generate the respective vector embeddings thereof; (ii) based on the respective vector embeddings of the given human request 212 and the respective in-use fact 703, generate a respective in-use concatenated vector embedding 706; and (iii) feed the respective in-use concatenated vector embedding 706 to the generative model 304, thereby causing the generative model 304 to generate the textual representation of the respective augmented machine-generated answer 714 to the given human request 212.

Further, the server 202 can be configured to transmit the textual representation of the respective augmented machine-generated answer 714 to the electronic device 204 of the user 206 for presentation of the respective augmented machine-generated answer 714 thereto. As mentioned hereinabove, in those embodiments where the chatbot system 210 further includes the TTS model, the chatbot system 210 can be configured to generate, based on the textual representation of the respective augmented machine-generated answer 714, a respective machine-generated utterance for further reproduction thereof for the user 206, using the speaker of the electronic device 204.

As mentioned hereinabove, by considering the context of the respective in-use fact 703, relevant to the given human request 212, the generative model 304 is configured to generate the respective augmented machine-generated answer 714 which can be perceived by the user 206 as being more natural and unrestrained, as well as relevant to the present, as opposed to the respective machine-generated answer 214 generated solely based on the given human request 212. This may improve the user experience of the user 206 with the chatbot system 210.

### Method

Given the architecture and the examples provided hereinabove, it is possible to execute a method for training the chatbot system 210 to generate machine-generated answers to users' requests of users of the chatbot system 210, such as the respective augmented machine-generated answer 714 responsive to the given human request 212 of the user 206.

As mentioned hereinabove, according to certain non-limiting embodiments of the present technology, the chatbot system 210 can comprise: (i) the embedding model 302 configured to generate the vector embeddings of the textual representations of the user requests, such as the respective in-use concatenated vector embedding 706 of the given human request 212; and (ii) the generative model 304 configured to generate, based on the respective in-use concatenated vector embedding 706, the textual representation of the respective augmented machine-generated answer 714.

According to some non-limiting embodiments of the present technology, each one the embedding model 302 and the generative model 304 can be implemented as a Transformer-based machine-learning model, having the machine-learning model architecture 400 described in detail above with reference to FIG. 4.

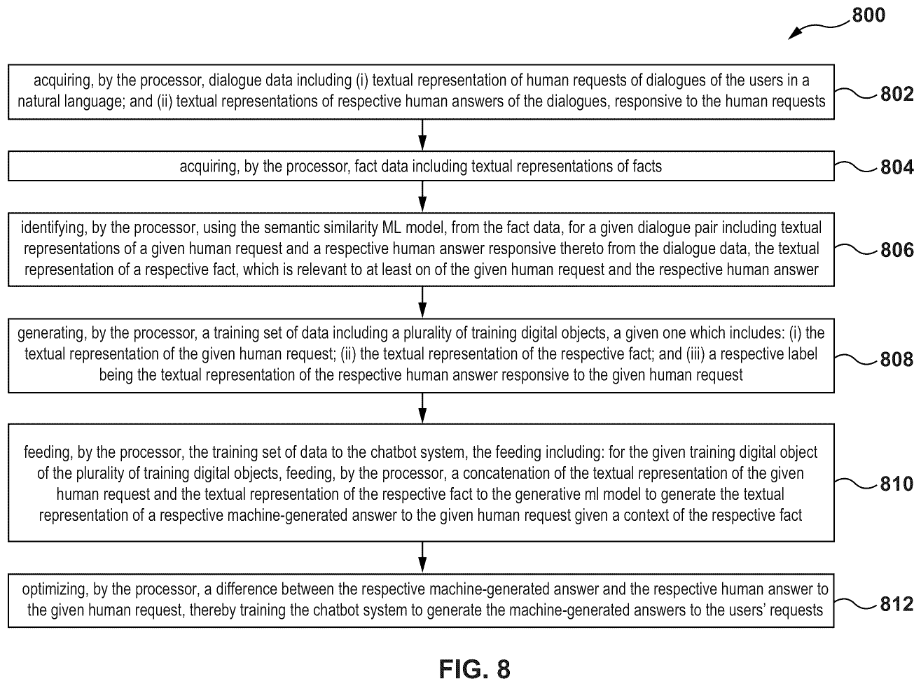

With reference now to FIG. 8, there is depicted a flowchart of a method 800, according to the non-limiting embodiments of the present technology. The method 800 can be executed by the server 202.

Step 802: Acquiring, by the Processor, Dialogue Data Including (I) Textual Representations of Human Requests of Dialogues of the Users in a Natural Language; and (II) Textual Representations of Respective Human Answers of the Dialogues, Responsive to the Human Requests

As mentioned hereinabove, according to certain non-limiting embodiments of the present technology, training the chatbot system 210 to generate the respective augmented machine-generated answer 714 in response to the given human request 212 can include two training stages. During the first training stage, also referred to as the “pre-training”stage, the server 202 can be configured to train the generative model 304 of the chatbot system 210 to generate the textual representation of the respective augmented machine-generated answer 714 to the given human request 212 based on training dialogue pairs “request-answer” in the natural language.

Further, during a second training stage, following the first one, which is referred to as the “fine-tuning” stage, along with the training dialogue pairs, the server 202 can also be configured to use factual data, providing context to respective training dialogue pairs. By doing so, the server 202 can be configured to train the generative model 304 to generate the textual representations of more natural and diverse machine-generated answers to the user requests.

Thus, the method 800 commences at step 802 with the server 202 being configured to acquire, for example, from the dialogue database 502, dialogue data including the textual representations of the plurality of training dialogue pairs in the natural language. For example, as was described above with reference to FIG. 5, the given training dialogue pair of the plurality of training dialogue pairs stored in the dialogue database 502 can include: (i) the textual representation of a given training human request 503; and (ii) the textual representation of a respective training human answer 505, responsive to the given training human request 503.

Further, as described in detail with reference to FIG. 5, the server 202 can be configured to generate the first plurality of training digital objects, the given training digital object 504 of which includes: (i) the textual representation of the given training human request 503; and (ii) the respective label being the textual representation of the respective training human answer 505. Further, the server 202 can be configured to feed each one of the first plurality of training digital objects to the generative model 304 without introducing thereto respective labels of the training digital objects. In other words, when feeding to the generative model 304 the given training digital object 504, in some non-limiting embodiments of the present technology, the server 202 can be configured to feed only the given training human request 503 (without feeding thereto the textual representation of the respective training human answer 505), thereby causing the generative model 304 to generate the textual representation of the respective training machine-generated answer 514. As noted hereinabove, to feed the given training human request 503 to the generative model 304, the server 202 can be configured to apply thereto the embedding model 302 trained as described above, thereby generating the respective training vector embedding 506, for further feeding to the generative model 304.

Further, the server 202 can be configured to optimize the difference between the respective training machine-generated answer 514 and the respective training human answer 505 as described above, thereby pre-training the generative model 304 to generate the textual representation of the respective augmented machine-generated answer 714 to the given human request 212.

Further, the server 202 can be configured to fine-tune the generative model 304 to generate the textual representation of the respective augmented machine-generated answer 714, as will be described at the following steps of the method 800.

The method 800 hence advances to step 804.

### Step 804: Acquiring, by the Processor, Fact Data Including Textual Representations of Facts

At step 804, the server 202 can be configured to acquire, for example, from the fact database 602 of the server 202, the fact data including the textual representations of various facts.

For example, certain facts stored in the fact database 602 can be indicative of common knowledge, such as “The Earth is round”, “COVID-19 is a disease caused by the SARS-CoV-2 coronavirus”, “Moscow is the capital of Russia”, and the like. However, in some non-limiting embodiments of the present technology, the fact database 602 can include the textual representations of facts specific to certain industries, such as the film industry, the law industry, the fast-moving customer goods (FMCG) industry, and the like. In this regard, a given entry of the fact database 602 can read “Avatar-2 earned more than $134 million worldwide on the opening weekend”, “Meryl Streep has won three Academy Awards”, “On Feb. 28, 2023, the show “Cunk on Earth” was rated 8.1 on IMDB”, and the like.

It is not limited how the fact database 602 can be populated. In some non-limiting embodiments of the present technology, the server 202 can be configured to populate the fact database 602 by crawling various resource of the communication network 208. For example, the server 202 can be configured to crawl certain reference resources (such as the Wikipedia™ online encyclopedia, the Britannica™ online encyclopedia, and the like), online news portals (such as the Yandex.News™ online news portal, the Rambler™ online news portal, and the like), or reference and news pages of at least one of the online listing platforms, the audio streaming platforms, and the video streaming platforms. Also, in other non-limiting embodiments of the present technology, the fact database 602 can be prepopulated by the third-party server without and made accessible by the server 202, without departing from the scope of the present technology.

Additionally, in some non-limiting embodiments of the present technology, the fact database 602 can be updated from time to time, for example, regularly (once a day, once a week, once a month, and the like) so that the facts stored in the fact database 602 are up-to-date.

The method 800 thus proceeds to step 806.

Step 806: Identifying, by the Processor, Using the Semantic Similarity Ml Model, from the Fact Data, for a Given Dialogue Pair Including Textual Representations of a Given Human Request and a Respective Human Answer Responsive Thereto from the Dialogue Data, the Textual Representation of a Respective Fact, which is Relevant to at Least One of the Given Human Request and the Respective Human Answer

At step 806, the server 202 can be configured to identify, in the fact database 602, for the given training dialogue pair of the plurality of dialogue pairs from the dialogue database 602, the respective training fact 603.

As described in detail above with reference to FIG. 6, according to certain non-limiting embodiments of the present technology, the server 202 can be configured to identify the respective training fact 603 as being relevant to the at least one of given training human request 503 and the respective training human answer 505. To that end, in some non-limiting embodiments of the present technology, the server 202 can be configured to: (i) feed the textual representations of each dialogue pair from the dialogue database 502 and the textual representations of the facts from the fact database 602 to the embedding model 302 to generate the respective vector embeddings in the respective vector embedding space; and (ii) determine the respective training fact 603 as that associated with the respective vector embedding which is closest to the respective vector embeddings of the at least one of the given training human request 503 and the respective training human answer 505 in the respective vector embedding space.

To determine the respective vector embedding associated with the respective training fact 603, which is closest to the respective vector embeddings of the at least one of the given training human request 503 and the respective training human answer 505, in some non-limiting embodiments of the present technology, the server 202 can be configured to apply a K-nearest neighbors algorithm. In other non-limiting embodiments of the present technology, instead of or in addition to the K-nearest neighbors algorithm, to identify the respective vector embedding associated with the respective training fact 603, the server 202 can be configured to apply the ranking function, such as one the Okapi BM25 and BM25+ ranking functions.

The method 800 hence advances to step 808.

Step 808: Generating, by the Processor, a Training Set of Data Including a Plurality of Training Digital Objects, a Given One of which Includes: (I) the Textual Representation of the Given Human Request; (II) the Textual Representation of the Respective Fact; and (III) a Respective Label being the Textual Representation of the Respective Human Answer Responsive to the Given Human Request

At step 808, the server 202 can be configured to generate the second plurality of training digital objects, the given other training digital object 604 of which includes: (i) the textual representation of the given training human request 503; (ii) the textual representation of the respective training fact 603 from the fact database 602; and (iii) the respective label being the textual representation of the respective training human answer 505.

Further, using the second plurality of training digital objects, the server 202 can be configured to fine-tune the generative model 304 to generate the textual representation of the respective augmented machine-generated answer 714 to the given human request 212.

The method 800 hence advances to step 810.

Step 810: Feeding, by the Processor, the Training Set of Data to the Chatbot System, the Feeding Including: For the Given Training Digital Object of the Plurality of Training Digital Objects, Feeding, by the Processor, a Concatenation of the Textual Representation of the Given Human Request and the Textual Representation of the Respective Fact to the Generative Ml Model to Generate the Textual Representation of a Respective Machine-Generated Answer to the Given Human Request Given a Context of the Respective Fact

At step 810, the server 202 can be configured to feed each one of the second plurality of training digital objects to the generative model 304, thereby fine-tuning the generative model 304 to generate the textual representations of respective augmented machine-generated answers to the user requests of users of the chatbot system 210. More specifically, in some non-limiting embodiments of the present technology, the server 202 can be configured to: (i) for each one of the second plurality of training digital objects, such as the given other training digital object 604, generate the concatenation of the textual representations of the given training human request 503 and the respective training fact 603 identified using the embedding model 302 as described above; and (ii) feed the concatenation of the textual representations of the given training human request 503 and the respective training fact 603 to the generative model 304, thereby causing the generative model 304 to generate the respective other training machine-generated answer 614.

In some non-limiting embodiments of the present technology, the server 202 can be configured to generate the concatenation of the textual representations of the given training human request 503 and the respective training fact 603 by generating a concatenation of the respective vector embeddings thereof generated, for example, by the embedding model 302 as described above. To that end, the server 202 can be configured to: (i) generate, based on the respective vector embeddings of the given training human request 503 and the respective training fact 603, the respective training concatenated vector embedding 606; and (ii) feed the respective training concatenated vector embedding 606 to the generative model 304, thereby causing the generative model 304 to generate the respective other training machine-generated answer 614.

The method 800 hence advances to step 812.

Step 812: Optimizing, by the Processor, a Difference Between the Respective Machine-Generated Answer and the Respective Human Answer to the Given Human Request, Thereby Training the Chatbot System to Generate the Machine-Generated Answers to the Users' Requests.

At step 812, the server 202 can be configured to optimize the difference between the respective other training machine-generated answer 614 and the respective label, which is the respective training human answer 505, which can be expressed by the loss function, examples of and approaches to optimizing which are non-exhaustively listed above. Further, using the backpropagation algorithm, at each training iteration, the server 202 can be configured to adjust the weights of the generative model 304. By doing so, the server 202 can be configured to fine-tune the generative model 304 to generate the textual representations of the respective augmented machine-generated answers to the user requests considering contexts provided by respective facts, determined as being relevant to the user requests.

Further, as described in detail with reference to FIG. 7 above, according to certain non-limiting embodiments of the present technology, the server 202 can be configured to use the chatbot system 210 to generate, based on the textual representations of the given human request 212 and the respective in-use fact 703, the textual representation of the respective augmented machine-generated answer 714.

Further, the server 202 can be configured to transmit the textual representation of the respective augmented machine-generated answer 714 to the electronic device 204 of the user 206 for presentation of the respective augmented machine-generated answer 714 thereto. As mentioned hereinabove, in those embodiments where the chatbot system 210 further includes the TTS model, the chatbot system 210 can be configured to generate, based on the textual representation of the respective augmented machine-generated answer 714, a respective machine-generated utterance for further reproduction thereof for the user 206, using the speaker of the electronic device 204.

The method 800 thus terminates.

Thus, by considering the context of the respective facts, determined as being relevant to the user requests, certain embodiments of the method 800 can allow generating machine-generated answers that can be perceived by the users of the chatbot system 210 as being more natural and unrestrained, as well as relevant to the present. This may help improve the user experience of the users with the chatbot system 210.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method of training a chatbot system to generate machine-generated answers to users' requests of users of the chatbot system, the chatbot system including: (i) a semantic similarity machine-learning (ML) model configured to identify respective facts relevant to the users' requests; and (ii) a generative ML model to be trained to generate textual representations of the machine-generated answers to the users' requests based on the users' request and the respective facts; the method comprising:
acquiring dialogue data including (i) textual representations of human requests of dialogues of the users in a natural language; and (ii) textual representations of respective human answers of the dialogues, responsive to the human requests;
acquiring fact data including textual representations of facts;
identifying, using the semantic similarity ML model, from the fact data, for a given dialogue pair including textual representations of a given human request and a respective human answer responsive thereto from the dialogue data, the textual representation of a respective fact, which is relevant to at least one of the given human request and the respective human answer;
generating a training set of data including a plurality of training digital objects, a given one of which includes: (i) the textual representation of the given human request; (ii) the textual representation of the respective fact; and (iii) a respective label being the textual representation of the respective human answer responsive to the given human request;
feeding the training set of data to the chatbot system, the feeding including:
for the given training digital object of the plurality of training digital objects, feeding a concatenation of the textual representation of the given human request and the textual representation of the respective fact to the generative ML model to generate the textual representation of a respective machine-generated answer to the given human request given a context of the respective fact; and
optimizing a difference between the respective machine-generated answer and the respective human answer to the given human request, thereby training the chatbot system to generate the machine-generated answers to the users' requests.

2. The method of claim 1, wherein the identifying, using the semantic similarity ML model, the respective fact for the given dialogue pair of textual representations comprises:
feeding each one of: (i) the textual representations of the human requests; (ii) the textual representations of the human answers; and (iii) the textual representations of the facts, to the semantic similarity ML model, to generate respective vector embeddings of each one of (i) the textual representations of the human requests; (ii) the textual representations of the human answers; and (iii) the textual representations of the facts;
mapping the respective vector embeddings to a vector space; and
identifying the respective fact relevant to the at least one of the given human request and the respective human answer as being a fact associated with the respective vector embedding that is closest to the respective vector embedding of the at least one of the given human request and the respective human answer in the vector space.

3. The method of claim 2, wherein the identifying further comprises applying a k-nearest neighbors algorithm.

4. The method of claim 2, wherein the identifying further comprises applying a heuristic algorithm.

5. The method of claim 4, wherein the heuristic algorithm comprises a ranking function.

6. The method of claim 5, wherein the ranking function is a BM25 ranking function.

7. The method of claim 1, wherein the respective fact is for providing a context to the given dialogue pair.

8. The method of claim 1, wherein the concatenation of the textual representation of the given human request and the textual representation of the respective fact comprises a concatenation of respective vector embeddings of the given human request and of the respective fact in a given vector space.

9. The method of claim 1, wherein the optimizing the difference comprises optimizing a loss function representative of the difference between the respective machine-generated answer and the respective human answer.

10. The method of claim 1, further comprising using the chatbot system for generating the machine-generated answers to the users' requests, the using comprising:
receiving the textual representation of an in-use human request of a given user;
identifying, using the semantic similarity ML model, from the fact data, the respective fact relevant to the in-use human request;
feeding a concatenation of the textual representations of the in-use human request and the respective fact to the generative ML model, thereby causing the generative ML model to generate the textual representation of a respective in-use machine-generated answer responsive to the in-use human request given the context of the respective fact.

11. The method of claim 1, wherein each one of the semantic similarity ML model and the generative ML model is a Transformer-based ML model.

12. The method of claim 11, wherein the generative ML model is devoid of an encoder portion of the Transformer-based ML model.

13. The method of claim 1, wherein the chatbot system is one of (i) a text-to-text chatbot system; (ii) text-to-speech chatbot system; (iii) a speech-to-text chatbot system; and (iv) a speech-to-speech chatbot system.

14. A server for training a chatbot system to generate machine-generated answers to users' requests of users of the chatbot system, the chatbot system including: (i) a semantic similarity machine-learning (ML) model configured to identify respective facts relevant to the users' requests; and (ii) a generative ML model to be trained to generate textual representations of the machine-generated answers to the users' requests based on the users' request and the respective facts; the server comprising: (i) at least one processor and (ii) at least one non-transitory computer-readable medium comprising executable instructions that, when executed by the at least one processor, cause the system to:
acquire dialogue data including (i) textual representations of human requests of dialogues of the users in a natural language; and (ii) textual representations of respective human answers of the dialogues, responsive to the human requests;
acquire fact data including textual representations of facts;
identify, from the fact data, using the semantic similarity ML model, for a given dialogue pair including textual representations of a given human request and a respective human answer responsive thereto from the dialogue data, the textual representation of a respective fact, which is relevant to at least one of the given human request and the respective human answer;
generate a training set of data including a plurality of training digital objects, a given one of which includes: (i) the textual representation of the given human request; (ii) the textual representation of the respective fact; and (iii) a respective label being the textual representation of the respective human answer responsive to the given human request;
feed the training set of data to the chatbot system, by:
for the given training digital object of the plurality of training digital objects, feeding, by the processor, a concatenation of the textual representation of the given human request and the textual representation of the respective fact to the generative ML model to generate the textual representation of a respective machine-generated answer to the given human request given a context of the respective fact; and
optimize a difference between the respective machine-generated answer and the respective human answer to the given human request, thereby training the chatbot system to generate the machine-generated answers to the users' requests.

15. The server of claim 14, wherein to identify the respective fact for the given dialogue pair of textual representations, using the semantic similarity ML model, the at least one processor further causes the system to:
feed each one of: (i) the textual representations of the human requests; (ii) the textual representations of the human answers; and (iii) the textual representations of the facts, to the semantic similarity ML model, to generate respective vector embeddings of each one of (i) the textual representations of the human requests; (ii) the textual representations of the human answers; and (iii) the textual representations of the facts;
map the respective vector embeddings to a vector space; and
identify the respective fact relevant to the at least one of the given human request and the respective human answer as being a fact associated with the respective vector embedding that is closest to the respective vector embedding of the at least one of the given human request and the respective human answer in the vector space.

16. The server of claim 14, wherein to identify the respective fact, the at least one processor further causes the system to apply a k-nearest neighbors algorithm.

17. The server of claim 14, wherein to optimize the difference, the at least one processor further causes the system to optimize a loss function representative of the difference between the respective machine-generated answer and the respective human answer.

18. The server of claim 14, wherein the at least one processor further causes the system to use the chatbot system for generating the machine-generated answers to the users' requests, by:
receiving the textual representation of an in-use human request of a given user;
identifying, using the semantic similarity ML model, from the fact data, the respective fact relevant to the in-use human request;
feeding a concatenation of the textual representations of the in-use human request and the respective fact to the generative ML model, thereby causing the generative ML model to generate the textual representation of a respective in-use machine-generated answer responsive to the in-use human request given the context of the respective fact.

19. The server of claim 14, wherein each one of the semantic similarity ML model and the generative ML model is a Transformer-based ML model.

20. The server of claim 19, wherein the generative ML model is devoid of an encoder portion of the Transformer-based ML model.
